(19) United States
(12) Patent Application Publication
(10) Pub. No.: US 2009/0094910 A1
(43) Pub. Date: Apr. 16, 2009

(54) Sealing Joint For A Window Assembly

(76) Inventors: Patrice Harnois, Ste. Elizabeth (CA); Marc Coutu, St. Thomas (CA); Pierre Lussier, Lavaltrie (CA)

Correspondence Address: ST. ONGE STEWARD JOHNSTON & REENS, LLC, 986 BEDFORD STREET, STAMFORD, CT, 06905-5619, US

(21) Appl. No.: 12/246,035

(22) Filed: Oct. 6, 2008

Related U.S. Application Data
(60) Provisional application No. 60/960,582, filed on Oct. 4, 2007.

(51) Int. Cl. E06B 3/30; E04B 1/66

(52) U.S. Cl. 52/203; 52/204.66; 52/741.4

(57) ABSTRACT

A sealing joint for a window assembly is including a screen and a window pane covering the screen is provided. The sealing joint includes an actuator for positioning the window pane between the open and closed positions, a plate mounted to the window assembly, the plate lying substantially in the plane of the screen, the plate comprising an opening. The sealing member also includes a sealing member being sized and shaped so as to cover the opening, the sealing member being adapted to slide over the plate while maintaining contact therewith and continuing to cover the opening. The sealing member includes an aperture being shaped and sized so as to receive the actuator therewithin. The actuator extends through the opening and the aperture. A window assembly comprising the sealing joint and a kit for a sealing joint are also provided.

### CROSS-REFERENCE TO RELATED APPLICATIONS

The present application claims the benefit under 35 U.S.C. §119 (e) of the U.S. Provisional Patent Application Ser. No. 60/960,582 filed on Oct. 4, 2007.

### FIELD OF THE INVENTION

The present invention relates to a joint for a window assembly, and more particularly, and in its preferred intended use, the present invention relates to a joint for a window assembly for preventing entry of insects into a structure.

### BACKGROUND OF THE INVENTION

Window assemblies comprising insect screens and the like are very well known in the art.

Indeed, a conventional window assembly normally consists of a transparent window pane provided within a window frame. In cases where it is desirable to open the window in order to, for example, allow air to enter or exit through the window, it is also desirable to block entry of large airborne debris, insects and other contaminants. This blocking is accomplished by placing a screen across the opening within the window frame.

In large structures, for example greenhouses, it can be desirable to provide the ability to vent the interior of the structure by opening the roof or wall panels. These panels may be window panels comprising a transparent pane, or may also be opaque wall panels. These panels are typically hinged along a first side and pushed outwards along an opposite second side. In the case of an angled roof, these panels are pushed upwards and away from the remaining roof by vertically extending actuators. Such an arrangement permits the natural ventilation of the environment within the structure, which is important for the growth of plants and other organisms.

Conventional window assemblies for such applications typically comprise blade or brush-like weather-stripping and the like to create deformable seals between the window frame and the actuators as they pass through the plane of the screen in order to lift the window panel.

In modern biological and genetic experimentation, for example in the bio-pharma fields experimenting on the growth of transgenic plant proteins and the like, preventing the contamination of the air, equipment and specimens within the structure is paramount. Moreover, many such structures must pass a certification process which requires them to show to a regulating body that their structures are impervious to certain categories of contaminants. An example of such certification is the biohazard levels 1, 2, 3, etc. However, it remains desirable in experimental greenhouses, for example to naturally ventilate the interior thereof via roof or wall panels. A major drawback associated with conventional sealing joints and window assemblies is that they do not provide an adequately close-fitting seal and cannot prevent the entry of a sufficient proportion of contaminants. Moreover, conventional sealing joints degrade with time, thereby further compromising their sealing ability, which is unacceptable in a strict experimenting environment.

Hence, in light of the aforementioned, there is a need to provide an improved sealing joint for a window assembly, which by virtue of its design and components, would be able to overcome some of the above-discussed prior art problems.

### SUMMARY OF THE INVENTION

It is therefore aspect of the present invention is to provide a sealing joint for a window assembly which, by virtue of its design and components, satisfies some of the above-mentioned needs and is thus an improvement over other related devices known in the prior art.

An aspect of the present invention to provide a joint for a window assembly with an increased sealing ability which is operable to allow the natural venting of a structure while remaining impervious to insect entry.

In accordance with the present invention, the above aspect is achieved, as will be easily understood, with a sealing joint such as the one briefly described herein and such as the one exemplified in the accompanying drawings.

More specifically, there is provided a sealing joint for a window assembly including a screen and a window pane covering the screen, the screen lying in a plane and the window pane being positionable between an open and a closed position. The sealing joint includes an actuator for positioning the window pane between the open and closed positions, a plate mounted to the window assembly, the plate lying substantially in the plane of the screen, the plate comprising an opening. The sealing member also includes a sealing member being sized and shaped so as to cover the opening, the sealing member being adapted to slide over the plate while maintaining contact therewith and continuing to cover the opening. The sealing member includes an aperture being shaped and sized so as to receive the actuator therewithin. The actuator extends through the opening and the aperture.

Preferably, the sealing member includes a first block and a second block, the first and second blocks being aligned so as to sandwich the plate on either side of the opening. More preferably, the first and second blocks are fixed to one another by a connector, the connector passing through the opening. More preferably still, the first and second blocks include corresponding apertures through which the actuator extends.

Preferably, the actuator has a U-shaped cross-section and the aperture has a corresponding U-shape.

Preferably, the actuator includes a rack having a plurality of teeth. More preferably, the sealing member has a dimension substantially perpendicular to the plane which is greater or equal to the pitch of the teeth.

Preferably, the screen is mounted to the window assembly along a peripheral slot and wherein the plate is received in the peripheral slot.

In accordance with another aspect of the present invention, there is provided a window assembly including a screen lying in a plane, a window pan covering the screen and being positionable between an open and a closed position; and a sealing joint. The sealing joint includes an actuator for positioning the window pane between the open and closed position, a plate mounted to the window assembly, the plate lying substantially in the plane of the screen, the plate comprising an opening, and a sealing member being sized and shaped so as to cover the opening, the sealing member being adapted to slide over the plate while maintaining contact therewith and continuing to cover the opening. The sealing member includes an aperture being shaped and sized so as to receive the actuator therewithin. The actuator extends through the opening and the aperture.

In accordance with yet another aspect of the invention, there is provided a kit for a sealing joint for a window assembly including a screen and a window pane covering the screen, the screen lying in a plane, the window pane being positionable between an open and a closed position. The kit includes an actuator for positioning the window pane between the open and closed positions, a plate for mounting to the window assembly, the plate operable to lie substantially in the plane of the screen, the plate comprising an opening, and a sealing member being sized and shaped so as to cover the opening, the sealing member operable to slide over the plate while maintaining contact therewith and continuing to cover the opening. The sealing member includes an aperture being shaped and sized so as to receive the actuator therewithin. The actuator is operable to extend through the opening and the aperture.

The invention and its advantages will be better understood by reading the following non-restrictive description of a preferred embodiment thereof, made with reference to the accompanying drawings.

### BRIEF DESCRIPTION OF THE DRAWINGS

The invention will be better understood upon reading the following non-restrictive description of the preferred embodiment thereof, made with reference to the accompanying drawings in which:

FIG. 1 is a perspective view of a portion of a structure comprising the sealing joint according a preferred embodiment of the present invention.

FIG. 1a is a close-up of a portion of the structure illustrated in FIG. 1.

FIGS. 2 and 3 are side views of a structure comprising the sealing joint according a preferred embodiment of the present invention.

FIGS. 3a and 3b are close-ups of a portion of the structure illustrated in FIG. 3.

FIGS. 4, 4a, 4b and 4c are perspective, side and exploded views of a sealing joint 30 according to a preferred embodiment of the present invention.

While the invention will be described in conjunction with example embodiments, it will be understood that it is not intended to limit the scope of the invention to such embodiments. On the contrary, it is intended to cover all alternatives, modifications and equivalents as may be included as defined by the appended claims.

### DETAILED DESCRIPTION OF THE INVENTION

In the following description, the same numerical references refer to similar elements. The embodiments shown in the figures are preferred, for exemplification purposes only.

In addition, although the preferred embodiments of the present invention as illustrated in the accompanying drawings comprise various components, etc., and although the preferred embodiments of the sealing joint, greenhouse and corresponding parts of the present invention as shown consist of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations therebetween, as well as other suitable geometrical configurations may be used for the sealing joint according to the present invention, as will be briefly explained herein and as can be easily inferred herefrom by a person skilled in the art, without departing from the scope of the invention.

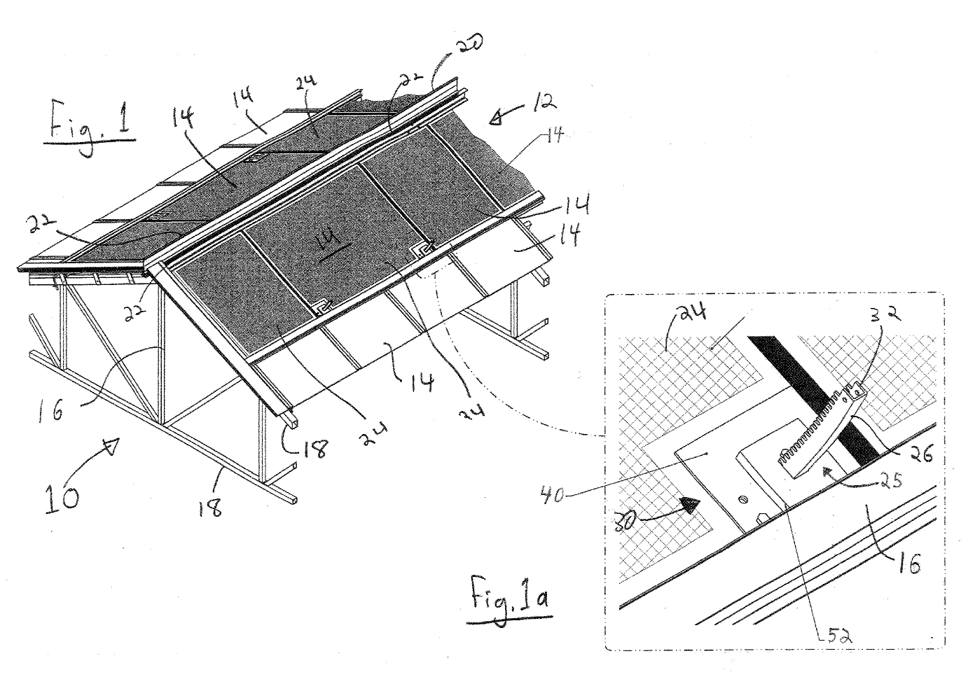

FIG. 1 illustrates a portion of a roof 12 of a structure 10. The roof 12 comprises a plurality of roof panels 14 which are supported by a frame 16 comprised of struts 18. In the illustrated embodiment, the roof panels 14 are part of a greenhouse 10 and, as such, are transparent window panes 14 and will be referred to as such. It will be appreciated, however, that this should not be interpreted in a limiting manner and that an embodiment wherein the window panes 14 are replaced with opaque or otherwise non-transparent panels 14 is well within the scope of the present invention.

The window panes 14 are arranged to form a sloping roof 12 with an apex 20 where the angled panes 14 meet along a longitudinal central axis. The uppermost panes 14 on either side of the apex 20 are operable to be opened. The greenhouse 10 comprises hinges 22 between the apex 20 and the openable panes 14 such that they may be opened by pushing their lower edges upwards.

In order to prevent entry of insects and other large debris into the interior of the greenhouse 10, screens 24 have been provided beneath each openable pane 14. These screens 24 are fixed to the frame 16 so as to remain in place while the openable panes are opened and closed.

It can be desirable to position the mechanisms required to open and close the panes 14 within the greenhouse 10, rather than outside it. As such, these mechanisms must pass from inside the greenhouse 10 to outside it in order to push the panes 14 into an open position.

FIG. 1a illustrates a close-up of an actuator 25 passing from inside the greenhouse 10 to outside it. In this manner, the actuator 25 can be said to be passing through the plane of the screen 24. For clarity, the transparent window pane 14 has been removed from this figure.

Whereas conventional window assemblies seal against such actuators 25 with blade or brush-type weather-stripping, the present invention provides a sealing joint 30, which is fixed to the greenhouse 10. The window pane 14, which is not illustrated in FIG. 1a, would attach to the extremity 32 of the actuator 25. A sealing joint 30 is preferably positioned in each of the lower corners of the screen 24.

The sealing joint 30 lies substantially in the plane of the screen 24. It is not necessary that the joint 30, or any particular element thereof, be aligned exactly with the screen 24. Rather, it will be appreciated that the sealing joint 30 may be provided above or below the plane of the screen 24, the importance being that the actuator 25 passes through the sealing joint 30 as opposed to through the screen 24. Moreover, while conventional windows and screens are flat, it will be appreciated that a sealing joint 30 in accordance with the present invention may also be provided for use with a curved panel and screen. In such an embodiment, the plane of the screen may be considered to be curved, the importance again being that the actuator passes through the sealing joint 30 as opposed to through the screen.

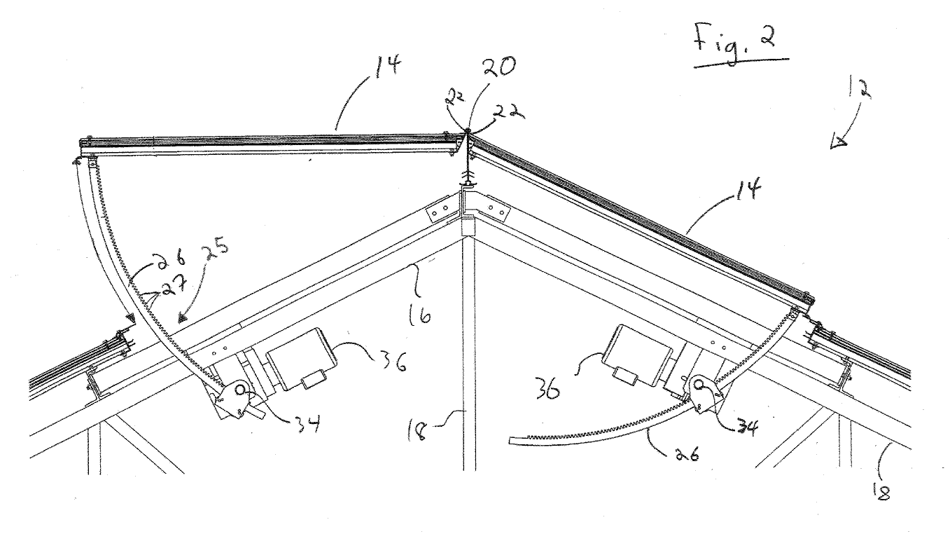

FIG. 2 illustrates a side view of the two opposing openable panes 14 of greenhouse roof 12 without the screens 24 installed. The left and right panes 14, which are both attached to the apex 20 via the hinges 22, are in an open and a closed position, respectively. In the illustrated embodiment, the actuator 25 comprises a curved rack 26 comprising a plurality of teeth 27, a corresponding pinion (not shown) and an electric motor 36 which drives the displacement of the rack 26 via the pinion. The pinion is housed within a bracket 34, which is mounted to the frame 16. The electric motor 36 may be operatively attached to a number of such pinions in order to engage more than one rack 26. As will be apparent to one skilled in the art, replacing the electric motor 36 with any other type of motor, or indeed a hand driven crank, is within the scope of the invention. It will further be apparent that alternative actuators 25, such as lead screws, piston cylinders and the like, are similarly within the scope of the invention.

In operation, the electric motor 36 drives the pinion, which in turn engages the teeth 27 and drives the curved rack 26 either inwards towards the closed position of the right pane 14, or the open position of the left pane 14. It will be apparent, however, that other types of racks 26 may be used to open the window panes 14.

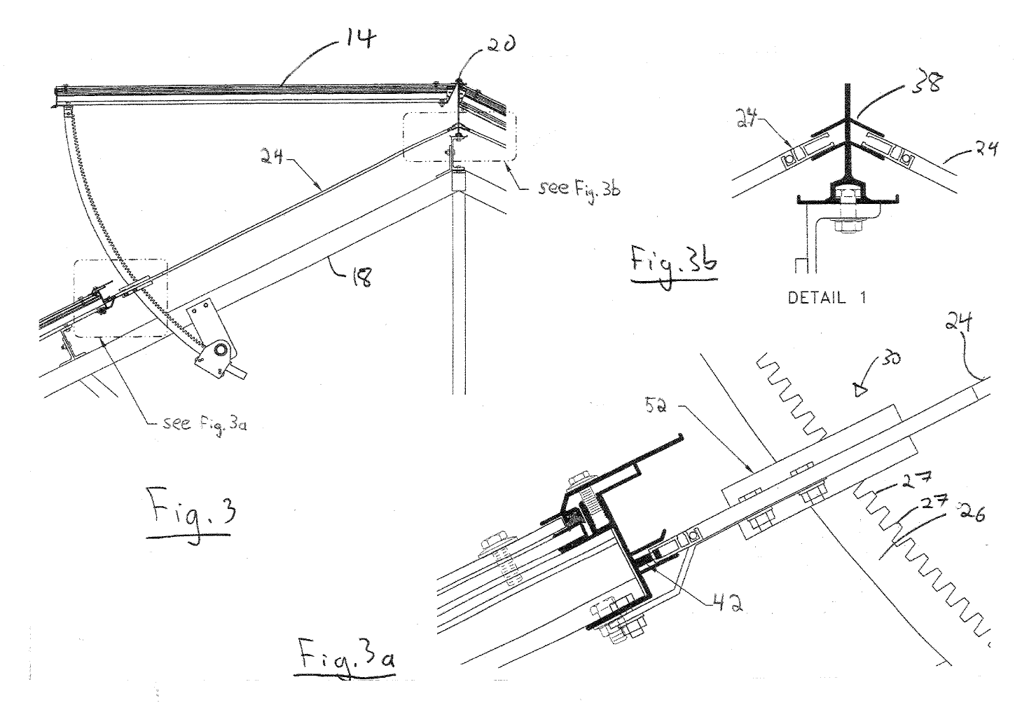

FIG. 3 illustrates a section of the roof 12 comprising an open pane 14 and a screen 24. In this position, the air within the greenhouse structure 10 is vented to the outside via the open window pane 14, but insects and the like are not able to enter.

As seen in FIG. 3a, the rack 26 passes through the plane of the screen 24 by passing through the sealing joint 30. FIG. 3b illustrates the upper extremities of two screens 24. These uppermost screens 24 are retained to the greenhouse frame 16 by a screen frame 38 below the apex 20 as is known in the art and will not be discussed further herein.

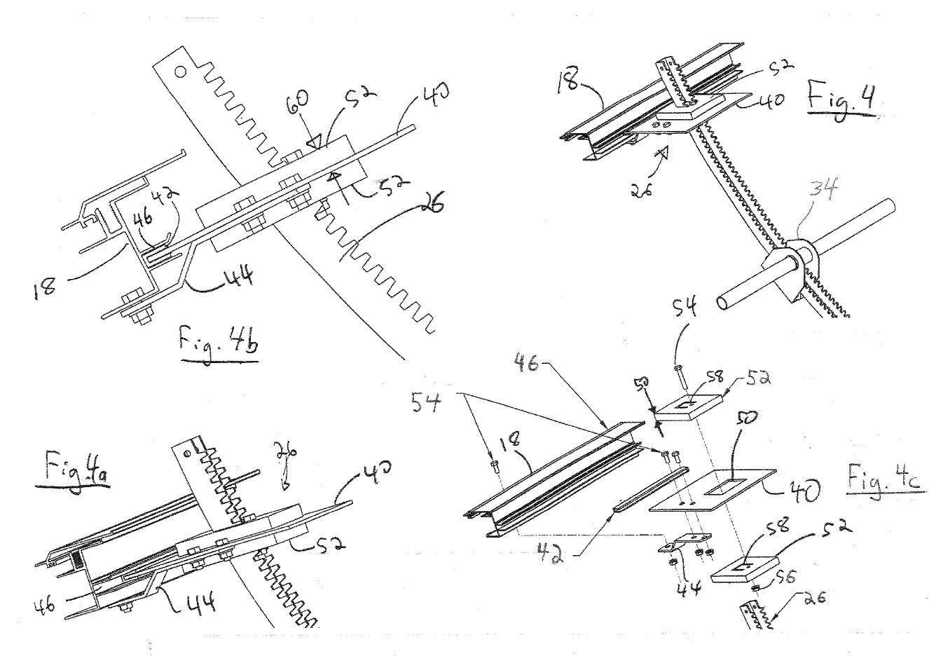

FIGS. 4 and 4a illustrate perspective views of the sealing joint 26, while FIG. 4b illustrates a side view thereof. FIG. 4c, for its part, illustrates an exploded view of the sealing joint 26.

The sealing joint 30 comprises a plate 40, which is fixed to a strut 18 via a resilient U-shaped bracket 42 and a support bracket 44. The plate 40 is preferably made of a rigid material, for example ⅛ inch (3.715 mm) aluminum plate. The plate 40 and bracket 42 are preferably retained in the same peripheral slot 46 as is used for the screen 24, thereby positioning the plate 40 in the plane of the screen 24.

The plate 40 comprises an opening 50 through which the rack 26 can pass when assembled. The opening 50 is of sufficient size to allow the rack 26 to extend therethrough despite any change in position of the rack 26 relative to the plate 40 due to, for example, thermal expansion/contraction of the rack 26 or any other elements of the greenhouse 10 which are connected thereto either directly or indirectly, or wind drag which may effect the pane 14 in an open position.

The opening 50 is covered by a sealing member 52. The sealing member 52 is sized and shaped so as to continue covering the opening throughout the above-mentioned changes in position of the rack 26 relative to the plate 40. The sealing member 52 comprises an aperture 58 which is shaped and sized so as to receive the rack 26. The sealing member 52 is adapted to slide over the plate 40 as it moves with the rack 26. As the rack 26 and sealing members 52 shift with respect to the plate 40 and the greenhouse 10, the sealing member 52 is constrained to the plate 40, that is to say it remains in contact with the plate 40 and continues covering the opening 50.

Preferably, the sealing member 52 comprises a pair of blocks 52 which are positioned on either side of the plate 40. These blocks 52 are clamped together by a bolt 54 and nut 56 which pass through the opening 50, thereby sandwiching the plate 40. The blocks 52 each comprise an aperture 58 which is manufactured to fit tightly around the rack 26.

In the illustrated embodiment, the rack 26 comprises a U-shaped cross-section, although other types of rack, such as T-shaped or hollow, are also well within the scope of the invention. In this embodiment, the apertures 58 are provided within the sealing blocks 52 in order to accommodate the U-shaped cross-section. Because the sealing blocks 52 sandwich the plate 40, they are not displaced by the translation of the rack 26 in a direction perpendicular to the plate as the pane 14 is opened and closed. However, because the sealing blocks 52 are not fixed directly to the plate 40 but rather sandwich it from the top and bottom, they are operable to translate in a direction parallel to the plane of the plate 40 while maintaining their sealing contact with the rack 26.

It will be appreciated that the degree to which inside of the greenhouse 10 is “sealed” from outside contaminants (or vice-versa), and hence the degree to which the sealing joint 30 must also prevent transmission of matter through and/or between its components, can vary from application to application. Preferably, the apertures 58 are manufactured with dimensional tolerances such that no space greater than the mesh size of the screen 24 is left around the rack 26. Similarly, it will be appreciated that sealing member 52 must seal against the plate where engage in the area surrounding the opening 50.

Because the rack 26 of the illustrated embodiment comprises a series of teeth 27, it varies in cross-section over its length. As such, the sealing blocks 52 and plate 40 are dimensioned such their total thicknesses is at least as large as the pitch of the teeth 27 of the rack 26. In this manner, an insect or other contaminant may not pass between a given pair of adjacent teeth 27 on either side of the sealing joint 30 and into the greenhouse 10. Preferably, the thickness 60 is given an additional 6 to 10 mm as a safety factor.

Preferably, the blocks 52 are made of an easily workable material, such as a high density thermoplastic. Even more preferably, the blocks 52 are formed from high density polyethylene.

As being now better appreciated, the present invention is an improvement and presents several advantages over other related devices and/or methods known in the prior art. Indeed, the present invention is particularly advantageous in that the actuator 25 is operable to slide through the sealing joint 30 without sacrificing any of the confinement offered by the screen 24. The present invention is further able to maintain the required sealing as it accommodates the various thermal expansion and/or other effects which would otherwise cause a misalignment in the system. Moreover, the present invention advantageously enables the proper dimensioning of the joint's elements in order to enable a close enough fit to satisfy the strict requirements of certification.

It will be appreciated that the location of panel 14 is not important to the functioning of the sealing joint 30, merely that it is openable. Moreover, the manner in which the panel 14 opens is also not essential to the functioning of the sealing joint 30. The panel may open via a hinged side, as in the figures, or may open outwards in one of the many other known ways in which panels may open . . . .

It will further be appreciated that while the illustrated embodiment comprises roof panes 14, such openable panes 14 could similarly be provided as part of wall. Moreover, it will be appreciated that the present Of course, numerous modifications could be made to the above-described embodiments without departing from the scope of the invention, as apparent to a person skilled in the art.

What is claimed is:

1. A sealing joint for a window assembly comprising a screen and a window pane covering the screen, the screen lying in a plane, the window pane being positionable between an open and a closed position, the sealing joint comprising:
a. an actuator for positioning the window pane between the open and closed positions;
b. a plate mounted to the window assembly, the plate lying substantially in the plane of the screen, the plate comprising an opening; and
c. a sealing member being sized and shaped so as to cover the opening, the sealing member being adapted to slide over the plate while maintaining contact therewith and continuing to cover the opening, the sealing member comprising:
i. an aperture being shaped and sized so as to receive the actuator therewithin;
wherein the actuator extends through the opening and the aperture.

2. The sealing joint of claim 1, wherein the sealing member comprises a first block and a second block, the first and second blocks being aligned so as to sandwich the plate on either side of the opening.

3. The sealing joint of claim 2, wherein the first and second blocks are fixed to one another by a connector, the connector passing through the opening.

4. The sealing joint of claim 2, wherein the first and second blocks comprise corresponding apertures through which the actuator extends.

5. The sealing joint of claim 1, wherein the actuator comprises a U-shaped cross-section and the aperture comprises a corresponding U-shape.

6. The sealing joint of claim 1, wherein the actuator comprises a rack comprising a plurality of teeth.

7. The sealing joint of claim 6, wherein the sealing member has a dimension substantially perpendicular to the plane which is greater or equal to the pitch of the teeth.

8. The sealing joint of claim 1, wherein the screen is mounted to the window assembly along a peripheral slot and wherein the plate is received in the peripheral slot.

9. A window assembly comprising:
a. a screen lying in a plane;
b. a window pan covering the screen and being positionable between an open and a closed position;
c. a sealing joint comprising:
i. an actuator for positioning the window pane between the open and closed position;
ii. a plate mounted to the window assembly, the plate lying substantially in the plane of the screen, the plate comprising an opening; and
iii. a sealing member being sized and shaped so as to cover the opening, the sealing member being adapted to slide over the plate while maintaining contact therewith and continuing to cover the opening, the sealing member comprising an aperture being shaped and sized so as to receive the actuator therewithin;
wherein the actuator extends through the opening and the aperture.

10. A kit for a sealing joint for a window assembly comprising a screen and a window pane covering the screen, the screen lying in a plane, the window pane being positionable between an open and a closed position, the kit comprising:
a. an actuator for positioning the window pane between the open and closed positions;
b. plate for mounting to the window assembly, the plate operable to lie substantially in the plane of the screen, the plate comprising an opening; and
c. a sealing member being sized and shaped so as to cover the opening, the sealing member operable to slide over the plate while maintaining contact therewith and continuing to cover the opening, the sealing member comprising:
i. an aperture being shaped and sized so as to receive the actuator therewithin;
wherein the actuator is operable to extend through the opening and the aperture.
